(19) United States
(12) Patent Application Publication
(10) Pub. No.: US 2012/0018419 A1
(43) Pub. Date: Jan. 26, 2012

(54) THERMODE ASSEMBLY

(75) Inventor: Wee Hock Chan, Singapore (SG)

(73) Assignee: TRIMECH TECHNOLOGY PTE. LTD., Singapore (SG)

(21) Appl. No.: 13/260,955

(22) PCT Filed: Apr. 5, 2010
(86) PCT No.: PCT/SG2010/000135

§ 371 Date: Sep. 29, 2011

(30) Foreign Application Priority Data
Apr. 2, 2009 (SG) PCT/SG2009/000122

(51) Int. Cl. H05B 3/12; H05B 3/02

(52) U.S. Cl. 219/541; 219/542; 219/200

(57) ABSTRACT

A thermode assembly comprises a heating element comprising a material having a first thermal expansion coefficient and a base comprising a material having a second thermal expansion coefficient lower than the first thermal expansion coefficient. The thermode assembly also comprises a tensioning mechanism for tensioning the heating element in contact with the base.

### FIELD OF THE INVENTION

The present invention relates to a thermode assembly. The invention has particular, but not exclusive, application, for bonding objects like printed circuits to glass substrates.

### BACKGROUND

A conventional precision pulse heat thermode is typically a heating instrument formed from a block of metal. The block of metal is shaped to form a folded blade having an elongate heating edge for heating objects in contact with it, a support structure and a mount for attaching the thermode to machinery (such as a robot arm), which may be operated to bring the thermode into contact with objects to be bonded. Electrical current is passed through the heating edge to heat it up.

Applications for the thermode includes bonding, for example, fine pitch flex printed circuit to a glass substrate with similar connection points. The folded blade typically includes a thin folded section, which forms the heating edge, and a thick block section, which forms the support structure and the mount.

A conventional thermode having the type of design as described above may serve its purpose well for applications not requiring high precision. However, it is expensive because of the amount of metal used to make it. Another drawback of this design is that warping of the heating edge would occur for longer lengths of the heating edge. Also, much electrical energy is required to heat up the heating edge.

Warping results in distortion of the heating edge and is caused by differences in temperature within the thermode, which gives rise to different expansion rates at different parts of the block of metal used to form the thermode. For bonding requiring high precision, warping can cause different bonding forces to be applied on the object along the length of the heating edge in contact with the object. This would result in uneven bonding, which is undesirable.

### SUMMARY

In accordance with a first aspect of the present invention, there is provided a thermode assembly comprising: a heating element comprising a material having a first thermal expansion coefficient; a base comprising a material having a second thermal expansion coefficient lower than the first thermal expansion coefficient; and a tensioning mechanism for tensioning the heating element in contact with the base.

The thermode assembly may comprise a clamp for clamping the heating element and for conducting electricity to the heating element.

The thermode assembly may comprise a bias for biasing the clamp in a direction away from the thermode assembly to tension the heating element.

The thermode assembly may comprise an adjustable fastener for fastening the clamp to the bias and for adjusting a distance by which the bias can bias the clamp in the direction away from the thermode assembly.

The heating element may comprise a metallic strip.

The thermode assembly may comprise at least one thermocouple.

The thermode assembly may comprise an air nozzle for cooling the heating element.

The heating element may be elongate and may have a first portion of a first width and a second portion of a second width, the first width being greater than the second width, the second portion of the heating element being in contact with the base.

The thermode assembly may comprise a support in contact with the first portion of the heating element for assisting in heat dissipation of the first portion.

In accordance with a second aspect of the present invention, there is provided a thermode assembly comprising: an elongate heating element formed of a material having a first thermal expansion coefficient; a base comprising a material having a second thermal expansion coefficient lower than the first thermal expansion coefficient; and a tensioning mechanism for tensioning the elongate heating element in contact with the base.

The thermode assembly according to the second aspect of the present invention may comprise at least two thermocouples welded to the heating element for temperature control and for safety interlocking purposes.

The thermode assembly according to the second aspect of the present invention may further comprise an air nozzle along the length of the heating element for cooling the heating element.

In accordance with a third aspect of the present invention, there is provided a thermode assembly comprising: a heating strip; and an air nozzle for cooling the thermode assembly.

The thermode assembly according to the second and third aspect of the present invention, wherein the tensioning mechanism may comprise an electrical connection in the form of a clamp for clamping the heating element and for conduction of electricity to the heating element.

### BRIEF DESCRIPTION OF THE DRAWINGS

Embodiments of the invention will be better understood and readily apparent to one of ordinary skill in the art from the following written description, by way of example only and in conjunction with the drawings, in which:

FIG. 1 is a front view of a first thermode assembly.

FIG. 2 is a side view of the thermode assembly of FIG. 1.

FIG. 3 is a bottom perspective view of a second thermode assembly.

FIG. 4 is a perspective view of a portion of the thermode assembly of FIG. 3.

### DETAILED DESCRIPTION

The acceptable surface distortion of the heating edge of thermodes for precision bonding is typically in the range of a few microns. It is thus desirable for thermodes used in precision bonding to be free from warping or distortions of other types. The thermode assemblies described herein are suitable for precision bonding without the problem of warping or distortions.

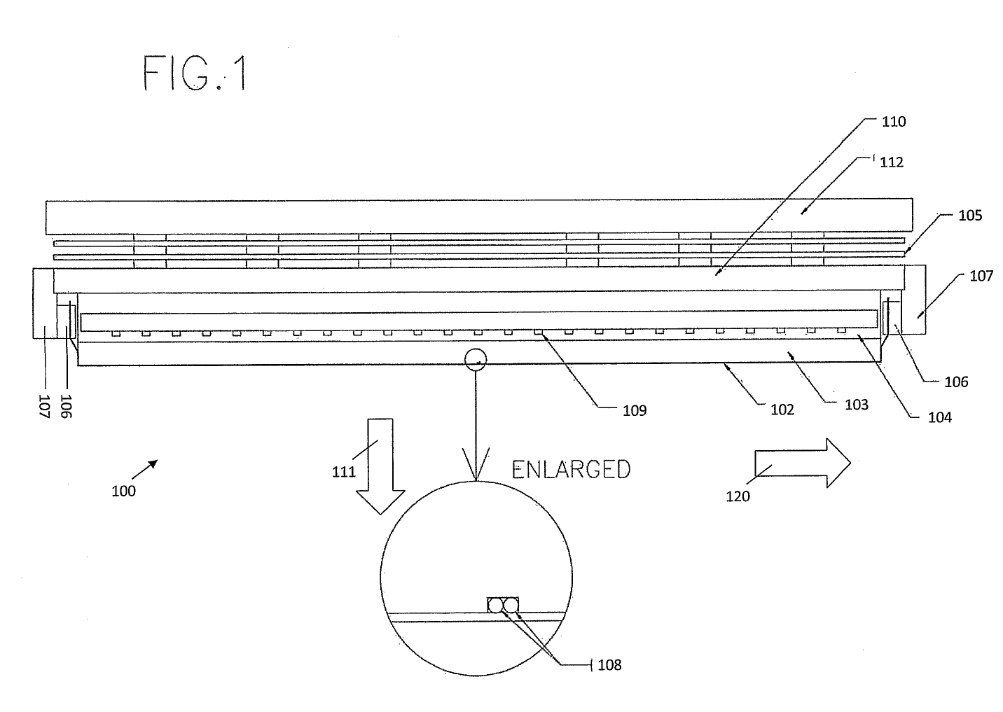

FIG. 1 shows a first thermode assembly 100 as can be used in a bonding process between a printed circuit and a glass substrate, or other similar objects.

Thermode assembly 100 has a heating element 102, which comprises, at least in part, of a material having a first thermal expansion coefficient. Thermode assembly 100 also has a base 103 which comprises, also at least in part, of a material having a second thermal expansion coefficient lower than the first thermal expansion coefficient. A tensioning mechanism is provided to tension the heating element 102 in contact with the base 103. In the example of FIG. 1, the tensioning mechanism is provided by way of tensioning mount 107 and clamp 106, as will be discussed in more detail below. In the example of FIG. 1, heating element 102 is a metallic strip formed of copper. Other similar materials may also be used.

The thermode assembly 100 also includes a rigid tension bar 110 on which tensioning mount 107 is mounted. In the example of FIG. 1, tension mounts 107 are provided on both ends of tension bar 110, but the thermode assembly will function with a single tensioning mount 107. Thermode assembly 100 also has an air cooling unit 109 for cooling the assembly, as will also be discussed in greater detail below.

The heating element 102 is an elongate metal strip uniform, or substantially uniform, width along its length. In the thermode assembly of FIG. 1, heating element 102 has no magnetic attraction properties, high ultimate tensile strength, high yield strength and modulus of elasticity, high electrical resistivity, for example, 1.0×10⁻⁶ to 1.5×10⁻⁶ ohm-metre at room temperature, high melting point, for example, between 1200 to 1600 degrees Celsius. One material suitable for use in the heating element 102 is Nichrome. It is appreciated that other materials having properties similar to those described above could also be used for the heating element 102.

The base 103 provides a rigid surface for contact with the heating element 102. Effectively, the base acts as a support for the heating element and, in conjunction with the tension force, works to keep heating element flat for a bonding operation, thereby obviating any adverse effects which would otherwise occur from distortion/expansion of the heating element. The base is formed, at least in part, of a material having a second thermal expansion coefficient lower than the thermal expansion coefficient of the heating element 102. The base may also be provided with electrically insulating properties.

Thermode assembly 100 is also provided with a clamp 106 for clamping the heating element and for conducting electricity to the heating element. An electrical power source is connected to the or each clamp 106 for electrical current to be passed through the heating element, which will cause it to expand with increased temperature.

Thermode assembly 100 also comprises a bias (here, included in tensioning mount 107) for biasing the clamp in a direction 120 away from the thermode assembly to tension the heating element. Effectively, the bias/tensioning mount 107 pulls the heating element 102 so that, when it expands with increased temperature, it is maintained taut. In this manner, any adverse effect on bonding operation caused by distortion is avoided.

As discussed, the thermal expansion coefficient of the base 103 is selected to be lower than that of the heating element so that the base does not expand or otherwise distort during the heating process which would, otherwise, have an adverse effect on the quality of bond. It is appreciated that the base 103 may be made of a ceramic or other similar material.

Thus, in the example of FIG. 1, the heating element 102 is kept straight and taut (under tension) by pulling on at least one and optionally both opposing end portions (using the tensioning mechanism) to straighten the heating element 102 longitudinally (i.e. along its length). The tensioning mechanism also operates to maintain the heating element in contact with a surface of the base 103.

The tensioning mount 107 is an intermediate structure between the tension bar 110 and the electrical connection 106. The tensioning mount 107 is spring loaded or provided with a bias, and designed to help maintain tension on the heating element 102 longitudinally. In some implementations, the tensioning mount 107 may be made of a material with Bakelite additives, to provide it with the ability to be an electrical insulator that would not affect the transfer of current sent to the heating element 102 via the electrical connection 106.

The thermode assembly 100 is mounted to a press head heat sink 105, which aids in heat dissipation of the thermode assembly 100. The heat sink 105 is also connected to a mounting bar 112. The mounting bar 112 is fixed to a linear motion actuator device (e.g. a robot arm, not shown in FIG. 1). During operation, the thermode assembly 100 is moved downwards in the direction indicated by arrow 111 by the linear motion actuator device to make contact with an object, in this case, the printed circuit or the glass substrate, for bonding.

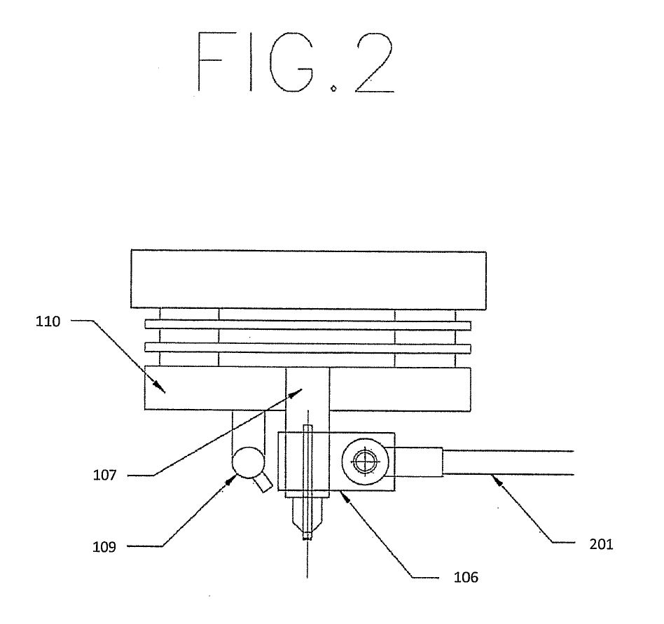

The air cooling unit 109 comprises one or more air nozzles for cooling the thermode assembly. In the example of FIG. 1, a plurality of air nozzles are located along the length of the heating element 102 and which are directed in the direction of the heating element 102 sitting on the base 103. FIG. 2 illustrates how the air nozzles are directed. The air cooling unit 109 is activated to blow air onto the heating element 102 to cool it after the bonding process. The cooling minimizes temperature transfer to the rest of the thermode assembly 100 and prevents overheating of the heating element 102.

It has been found that the air nozzle 109 is a particularly advantageous feature and, as such, may also be provided separately, In which case a thermode assembly comprises a heating strip and an air nozzle for cooling the thermode assembly,

When the heating element 102 cools—naturally, or with forced cooling from an air nozzle as described above—heating element 102 will contract. Accordingly, bias/tensioning mount 107 will contract as well, in a direction opposite direction 120, still maintaining tension on the heating element 102.

The thermode assembly 100 of FIG. 1 has one or more thermocouples for thermal protection of the assembly. In thermode assembly 100, two slots 108 for siting thermocouples are provided. These may be provided—to the heating element 102 and/or be located at the midpoint (see enlarged view in FIG. 1) of the heating element 102. The thermocouples are used for temperature control, monitoring and for safety interlocking (or, in other words, safety electrical power shut off) purposes.

It is appreciated that one or more thermocouple can be connected at other positions along the heating element 102 for the same purposes. One thermocouple may be provided for feedback to a main control station (Not shown in the Figures) controlling the bonding process to indicate whether to reduce or increase current passing through the heating element 102 so as to decrease or increase its heating temperature respectively. Another thermocouple may be provided for monitoring the heating element 102 to ensure it operates within safe operating temperatures. If the temperature of the heating element 102 goes beyond a certain threshold temperature, for instance, 600 degrees Celsius, electrical power heating the heating element 102 would be shut off to prevent the heating element 102 from overheating.

FIG. 2 shows the side view of the thermode assembly 100 as described with reference to FIG. 1. The heating element 102 is heated up to a temperature for bonding by passing current through it via its two opposing end portions. Being a thin metal strip, the heating element 102 has high electrical resistance, which causes it to heat up when current is passed through it. An electrical conductor 201 is attached to the electrical connection 106 at each opposing end portion of the heating element 102 connecting the heating element 102 to the electrical power source.

The thermode assembly 100 as described with reference to FIGS. 1 and 2 advantageously solves the problem of warping by, amongst other things, separating the heating element 102 from the tension bar 110 of the thermode assembly 100 by a base 103. In conventional thermodes, the heating element 102 and the support structures of the thermode are all part of the same block of metal, which as discussed earlier, has issues with warping. The base 103 is a thermally stable block having a low thermal expansion when heated. When the heating element 102 is heated, the base 103 is not affected by the expansion of the heating element 102. As such, warping of the heating element 102 due to the expansion of the insulator base 103 would not occur in the thermode assembly 100.

Furthermore, the thermode assembly of FIG. 1, the tensioning mechanism (i.e. the two tensioning mounts 107) is arranged to subject the heating element 102 to constant tension. The constant tension is created by forces pulling on the opposing end portions of the heating element 102. The constant tension is applied even when the heating element 102 is heated and expanded. Therefore the heating element 102 is constantly kept straight and taut and in engagement with the base 103. The heating element 102 is kept straight and taut constantly to ensure that the heated heating element 102 does not form kinks when it expands. Such kinks would adversely affect bonding precision.

It is appreciated that while the thermode assembly 100 of FIG. 1 is subject to constant tension by the tensioning mechanism, the tensioning mechanism can alternatively be arranged such that tensioning is applied only when necessary, for instance, just before the heating element 102 comes into contact with an article for bonding. Such arrangement can advantageously improve the usage lifetime of the heating element 102 as the heating element 102 is not constantly under tension.

It is further appreciated that due to the form factor (i.e. a thin metal strip) of the heating element 102 in the thermode assembly 100, only a small amount of electrical energy is required to heat it up compared to the electrical energy required to heat up a conventional thermode. It is also advantageously faster to cool it due to the form factor.

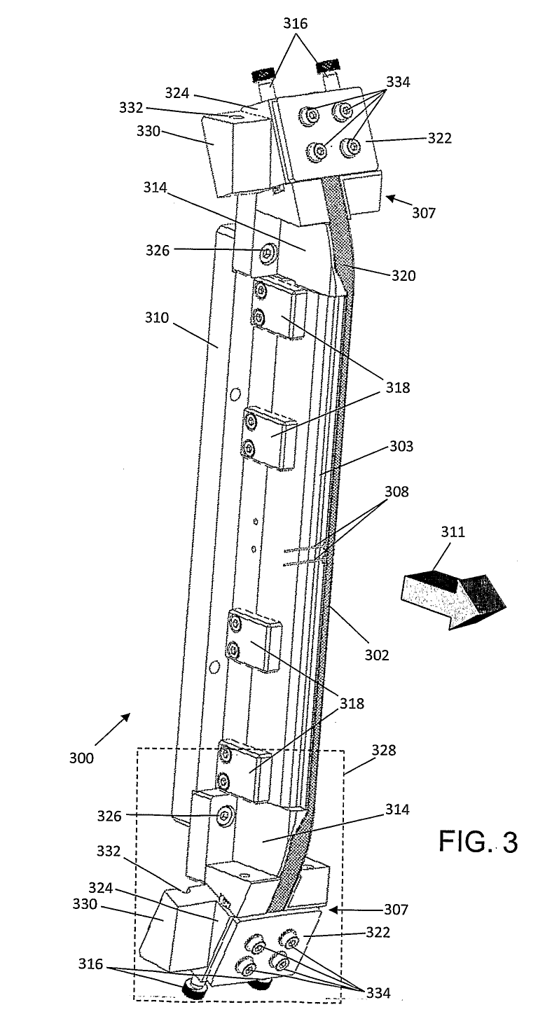

In alternative implementations, the press head heat sink 105 may be removed to cut cost and the tension bar 110 could be fixed directly to the linear motion actuator device (not shown in FIG. 1). The air cooling unit 109 is also an optional part and may be removed to cut cost. In the example of FIG. 3 which now follows, neither a heat sink nor an air cooling unit are present.

Thus, FIG. 3 shows a second thermode assembly 300 which operates in accordance with the general principles of the thermode assembly of FIGS. 1 and 2. The thermode assembly 300 includes a support bar 310, a heating element 302, an insulator base 303, a tensioning mount 307 on each of the symmetrical side of the thermode assembly 300, and a support 314 on each of the symmetrical side of the thermode assembly 300. The support 314 is an intermediate structure located between the tensioning mount 307 and the base 303 at the opposing end portions of the heating element 302.

The heating element 302 is similar to the heating element 102 described with reference to FIGS. 1 and 2 except that it is not entirely in the shape of a thin metal strip of uniform width along its length. The width of at least one of the opposing end portions of the heating element 302 is greater than the width of the portion of the heating element 302 in contact with the base 303. Thus, the heating element is elongate and has a first portion of a first width and a second portion of a second width, the first width being greater than the second width, the second portion of the heating element being in contact with the base. For ease of reference, each (or both) of the two opposing end portions of the heating element 302 are referred to as a first portion of the heating element 302 and the portion of the heating element 302 in contact with the base 303 is referred to as a second portion of the heating element 302.

In the example of FIG. 3, the or each first portion of the heating element 302 is made wider to reduce temperature rise at these portions and to concentrate heating to the second portion of the heating element 302 The second portion of the heating element 302 in contact with the base 303 is for placing in contact with the object to be bonded. The first portion of the heating element 302 is not for coming into contact with the object, hence heating is not required at these wider portions. It is appreciated that by being wider, there is less electrical resistance, hence lesser heating in the first portion of the heating element 302.

The insulator base 303 is similar to the insulator base 103 described with reference to FIGS. 1 and 2. The insulator base 303 is mounted to the support bar 310 via screw mounts 318.

In the second thermode assembly of FIG. 3, the support 314 is made of a thermally conductive material. It is also desirable, but not essential, that support 314 is made of a material which does not rust, for example, stainless steel although other materials having properties similar to those described above could also be used for the support 314. The support 314 is thermally conductive so that it assists in heat dissipation of the first portion of the heating element 302 in contact with the support 314. Furthermore, in the thermode assembly of FIG. 3, the surface of the support 314 in contact with the heating element 302 is arcuate and/or provided with a smooth or polished finish and/or coated with low surface friction/non-stick material, such as PTFE Teflon. The reason for having an arcuate and smooth surface is to reduce friction between the heating element 302 and base 303 when the heating element 302 is heated and expanding longitudinally (i.e. along its length). In thermode assembly 300, use of a material such as stainless steel for support 314 contributes to reduced-friction operation, as this material will not rust which would, otherwise, hinder sliding of the heating element 302 and limit the usage lifetime of the thermode assembly 300.

The support bar 310 is similar to the support bar 110 described with reference to FIGS. 1 and 2.

The tensioning mount 307 on each symmetrical side of the thermode assembly 300 is joined to the support bar 310 via mounting screws 326. The tensioning mount 307 is in the form of a screw mount comprising two halves, a clamping plate 322 and a clamp base 324. The clamping plate 322 and a clamp base 324 on each symmetrical side of the thermode assembly 300 are screwed together by screws 334 to hold the first portion of the heating element 302. In the thermode assembly of FIG. 3, the tensioning mount 307 is made of electrically conductive material.

The two tensioning mounts 307 operate in a manner to provide a tensioning mechanism for tensioning the heating element 302 in engagement with the base 303.

In the similar fashion as the heating element 102 described with reference to FIGS. 1 and 2, the heating element 302 is kept straight and taut (under tension) by pulling on its opposing end portions (using the tensioning mechanism) to 302 straighten the heating element 302 longitudinally (i.e. along its length) and by pressing it over the surface of the base 303.

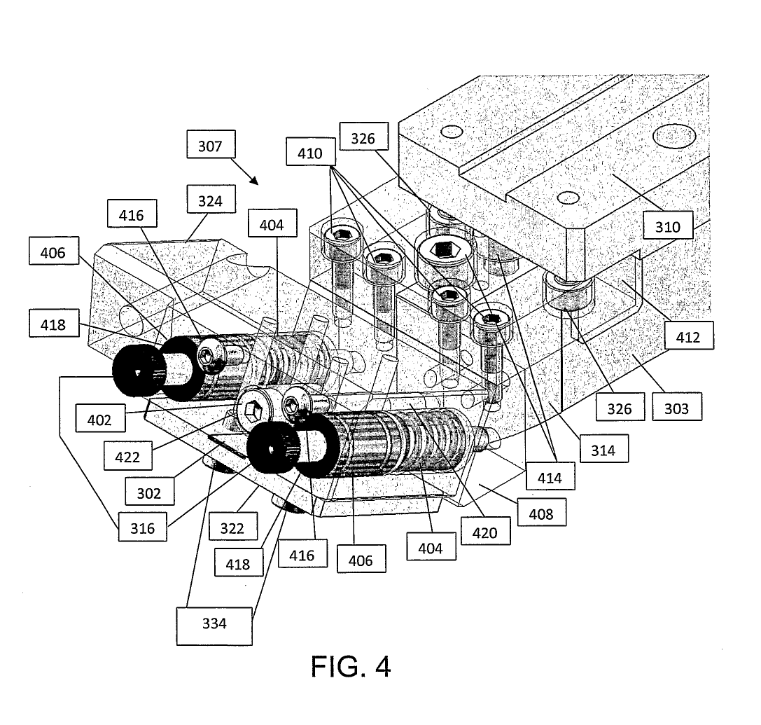

The heating element 302 is maintained under tension so that even when it expands on the application of heat to it, the expanded heating element 102 is kept straight and taut. More details on the tensioning of the heating element 302 for the thermode assembly of FIG. 3 are described below with reference to FIG. 4.

When in use, the support bar 310 of the thermode assembly 300 is fixed directly to a linear motion actuator device (e.g. a robot arm, not shown in FIG. 3). During operation, the thermode assembly 100 is moved in the direction indicated by arrow 311 by the linear motion actuator device to make contact with an object, in this case, the printed circuit or the glass substrate, for bonding.

Two thermocouple wires 308 for connecting at least one thermocouple to the heating element 302 is located at the midpoint of the heating element 302. The thermocouples are used for temperature control, monitoring and for safety interlocking (or safety shut off) purposes. It is appreciated that one or more thermocouples can be connected at other positions along the heating element 302 for the same purposes. In an alternative implementation, there could be two or more thermocouples where one thermocouple is for providing feedback to a main control station (Not shown in the Figures) controlling the bonding process to indicate whether to reduce or increase current passing through the heating element 302 so as to decrease or increase its heating temperature respectively. Another thermocouple could be for monitoring the heating element 302 to ensure it operates within safe operating temperatures. If the temperature of the heating element 302 goes beyond a certain threshold temperature, for instance, 600 degrees Celsius, electricity heating the heating element 302 would be shut off to prevent the heating element 302 from overheating.

Each tensioning mount 307 has an electrical connection block 330 extending from it. Each electrical connection block 330 (note: there are two of them, one on each symmetrical side of the thermode assembly 300) comprises a threaded screw hole 332 for screwing in an electrical terminal (not shown in FIG. 3). Each electrical terminal (note: there are two of them, one on each symmetrical side of the thermode assembly 300) connected to the electrical connection block 330 is in turn connected to an electrical power source to form a closed circuit for transmitting electricity to the heating element 302 via the tensioning mount 307.

Similar to the thermode assembly 100 as described with reference to FIGS. 1 and 2, the thermode assembly 300 advantageously solves the problem of warping by, amongst other things, separating the heating element 302 from the support bar 310 of the thermode assembly 300 by a base 303. When the heating element 302 is heated, the thermally stable base 303 is not affected by the expansion of the heating element 302.

Furthermore, in thermode assembly 300, the tensioning mechanism (i.e. the two tensioning mounts 307) is arranged to maintain the heating element 302 under tension. The tension is created by forces pulling on the opposing end portions of the heating element 302, as is generally described above with reference to FIG. 1.

It is appreciated that due to the form factor, i.e. the thinner metal strip portion between the wider opposing end portions, of the heating element 302 in the thermode assembly of FIG. 3, lesser amount of electrical energy is required to heat the thinner metal strip portion compared to the electrical energy required to heat up a conventional thermode. Advantageously, it also cools faster due to the form factor.

FIG. 4 illustrates in more detail how the tensioning mount 307 described in FIG. 3 clamps on the heating element 302 and subjects it under tension to keep it straight and taut and in engagement with the base 303. FIG. 4 is a rotated and enlarged view of the part 328 marked in FIG. 3.

In the example of FIG. 4, the tensioning mount 307 consists of four sections, the clamping plate 322 and the clamp base 324, a first coupling piece 408, and a second coupling piece 412. The clamp base 324, the first coupling piece 408, and the second coupling piece 412 are deliberately made transparent in FIG. 4 to illustrate how the pieces are mounted together and to aid in the understanding of how the tension of the heating element 302 is maintained.

As mentioned earlier, the clamping plate 322 and the clamp base 324 are screwed together to hold the heating element 302 at its two opposing end portions to keep it straight and taut (under tension).

The clamp base 324 is joined to the first coupling piece 408 with the aid of a shank fastener 402. The clamp base 324 is kept at an angle with respect to the longitudinal axis (along the length) of the thermode assembly 300. The shank fastener 402 is slotted into a central through-hole 422 in the clamp base 324 and the tail end 420 of the shank fastener 402 is screwed to the first coupling piece 408.

Two hand-screwed shank screws 316 are slotted into two through-holes 418 in the clamp base 324 respectively and are screwed to the first coupling piece 408. Each of the through-holes 418 in the clamp base 324 contain a hollow centre bushing 406 embedded with a spring 404. The two hand-screwed shank screws 316 are each slotted through the hollow centre bushings 406 and they are in sliding contact with the walls of the hollow centre of the bushings 406. Such sliding contact is preferred to allow for movement of the clamp base 324. The springs 404 are held in compression. Two round head screws 416 keeps the bushings 406 within its respective positions in the clamp base 324 and prevent them from dislodging from the through-holes 418 due to the stored energy in the compressed springs 404.

The first coupling piece 408 is mounted to the second coupling piece 412 via four short shank mounting screws 410. The second coupling piece 412 is mounted to the tension bar 310 through mounting screws 326. The curved and smooth support 314 is mounted to the second coupling piece 412 via big head mounting screws 414.

Bearing in mind that each opposing end portion of the heating element 302 is clamped to the clamp base 324 by the clamping plate 322, based on the aforementioned arrangement, the compressed springs 404 essentially push the clamp base 324 away from the first coupling piece 408 (i.e. similar to the biasing in the direction 120 of FIG. 1), thereby resulting in pulling of the heating element 302 and pressing of the heating element 302 over the insulator pad 303 (and additionally over the two curved supports 314) to keep the heating element 302 under tension.

The shank fastener 402 fastens the clamp base 324 to the first coupling piece 408 to prevent the clamp base 324 from being pushed too far away from the thermode assembly 300 under the bias of the springs 404. The shank fastener 402 limits the distance in which the clamp base 324 could be pushed away from the first coupling piece 408 by the springs 404. Thus, thermode assembly 300 has an adjustable fastener for fastening the clamp to the bias and for adjusting a distance by which the bias can bias the clamp in the direction away from the thermode assembly.

Sufficient distance between the clamp base 324 and the first coupling piece 408 is required to allow the heating element 302 to be tensioned even when it has expanded during heating. Therefore, the shank fastener 402 is screwed (or, in other words, adjusted) to an extent that would provide sufficient distance for the clamp base 324 to be pushed away from the first coupling piece 408 by the springs 404 even in the case where the heating element 302 has expanded.

Furthermore, it is noted that the two hand-screwed shank screws 316 should be long enough so that their screw heads would not limit the distance which the clamp base 324 could be pushed away from the first coupling piece 408.

Of course it will be appreciated that biases other springs as herein described can be used to bias the clamp base 324 away from the first coupling piece 408 to keep the heating element 302 under tension.

It will be appreciated that the bonding process may be carried out such that heating of the heating element (e.g. 102 in FIGS. 1 and 2 and 302 in FIG. 3) is carried out only at the time of bonding so as to reduce energy wastage.

It will also be appreciated that the base (e.g. 103, 303 in FIGS. 1 and 3) and the heating element (102, 302 in FIGS. 1 and 3) could be formed into other shapes as required by the bonding or heating process. For instance, the heating element may be horse shoe shaped, or held in U shaped etc. and the base is shaped accordingly to allow the heating element in contact with the base to be tensioned by the tensioning mechanism.

It is appreciated that while the thermode assembly 300 of FIG. 3 is subject to constant tension by its tensioning mechanism, the tensioning mechanism can alternatively be arranged such that tensioning is applied only when necessary, for instance, just before the heating element 302 comes into contact with an article for bonding. Such arrangement can advantageously improve the usage lifetime of the heating element 302 as the heating element 302 is not constantly under tension.

Many modifications and other embodiments can be made to the thermode assembly by those skilled in the art having the understanding of the above described disclosure together with the drawings. Therefore, it is to be understood that the thermo assembly and its utility is not to be limited to the above description contained herein only, and that possible modifications are to be included in the claims of the disclosure.

1.-14. (canceled)

15. A thermode assembly comprising:
a heating element comprising a material having a first thermal expansion coefficient;
a base comprising a material having a second thermal expansion coefficient lower than the first thermal expansion coefficient; and
a tensioning mechanism for tensioning the heating element in contact with the base.

16. The thermode assembly as claimed in claim 15, wherein the tensioning mechanism is arranged to tension the heating element in contact with the base by subjecting the heating element to constant tension created by a force pulling on at least one end portion of the heating element.

17. The thermode assembly as claimed in claim 15, further comprising a clamp for clamping the heating element and for conducting electricity to the heating element.

18. The thermode assembly as claimed in claim 17, further comprising a bias for biasing the clamp in a direction away from the thermode assembly to tension the heating element.

19. The thermode assembly as claimed in claim 18, further comprising an adjustable fastener for fastening the clamp to the bias and for adjusting a distance by which the bias can bias the clamp in the direction away from the thermode assembly.

20. The thermode assembly as claimed in claim 15, wherein the heating element comprises a metallic strip.

21. The thermode assembly as claimed in claim 15, further comprising at least one thermocouple.

22. The thermode assembly as claimed in claim 15, further comprising an air nozzle for cooling the heating element.

23. The thermode assembly as claimed in claim 15, wherein the heating element is elongate and has a first portion of a first width and a second portion of a second width, the first width being greater than the second width, the second portion of the heating element being in contact with the base.

24. The thermode assembly as claimed in claim 23, further comprising a support in contact with the first portion of the heating element for assisting in heat dissipation of the first portion.

25. A thermode assembly comprising:
an elongate heating element formed of a material having a first thermal expansion coefficient;
a base comprising a material having a second thermal expansion coefficient lower than the first thermal expansion coefficient; and
a tensioning mechanism for tensioning the elongate heating element in contact with the base.

26. The thermode assembly as claimed in claim 25, further comprising at least two thermocouples welded to the heating element for temperature control and for safety interlocking purposes.

27. The thermode assembly as claimed in claim 25, further comprising an air nozzle along the length of the heating element for cooling the heating element.

28. A thermode assembly comprising:
a heating strip; and
an air nozzle for cooling the heating strip, the air nozzle being directed to blow air onto the heating strip.

29. The thermode assembly as claimed in claim 28, further comprising a plurality of air nozzles for cooling the thermode assembly.

30. The thermode assembly as claimed in claim 25, wherein the tensioning mechanism comprises an electrical connection in the form of a clamp for clamping the heating element and for conduction of electricity to the heating element.
